(19) United States
(12) Patent Application Publication
(10) Pub. No.: US 2019/0227220 A1
(43) Pub. Date: Jul. 25, 2019

(54) LIGHTING DEVICE AND DISPLAY DEVICE

(71) Applicant: SHARP KABUSHIKI KAISHA, Osaka (JP)

(72) Inventors: TAKESHI MASUDA, Sakai City (JP); TAKESHI ISHIDA, Sakai City (JP)

(21) Appl. No.: 16/249,257

(22) Filed: Jan. 16, 2019

(30) Foreign Application Priority Data
Jan. 19, 2018 (JP) 2018-007046

(51) Int. Cl. F21V 8/00; G02B 1/11; G02F 1/1335

(52) U.S. Cl. CPC G02B 6/0053; G02B 6/0055; G02B 6/0091; G02F 1/133528; G02F 2001/133541; G02B 1/11

(57) ABSTRACT

A lighting device includes a light source having a light exit surface, and a prism sheet covering the light exit surface. The prism sheet includes prism portions, a first light reflecting portion that covers a part of a surface of the prism portions opposite from the light exit surface, and a second light reflecting portion that covers the first light reflecting portico from as opposite side from the light exit surface and has light reflectance lower than that of the first light reflecting portion.

### CROSS REFERENCE TO RELATED APPLICATION

This application claims priority from Japanese Patent Application No. 2018-007046 filed on Jan. 19, 2018. The entire contents of the priority application are incorporated herein by reference.

### TECHNICAL FIELD

The technology described herein relates to a lighting device and a display device.

### BACKGROUND

There has been known a lighting device including an optical film through which exit light is directed toward a display panel. The optical film includes prisms and a direction in which light rays exiting the lighting device are controlled by the prisms. By controlling the light exit direction, light is less likely to be reflected undesirably by the front glass. Such a lighting device is described in Japanese Unexamined Patent Application Publication No. 2007-164193.

In the above configuration, the light that has passed through the optical film is supplied to the display panel that is a component to be lighted. In such a configuration, the light supplied to the display panel may be reflected by a surface of the display panel or within the display panel toward the lighting device and the reflected light may be reflected by the optical film again and exit the lighting device toward the component to be lighted. The exiting direction of such light is not restricted and may exit in other direction than the desired exit direction.

### SUMMARY

The technology described herein was made in view of the above circumstances. An object is to surely control a light exit direction of light exiting a lighting device.

To solve the above problems, a lighting device of the present technology includes a light source having a light exit surface, and a prism sheet covering the light exit surface. The prism sheet includes prism portions, a first light reflecting portion that covers a part of a surface of the prism portions opposite from the light exit surface, and a second light reflecting portion that covers the first light reflecting portion from an opposite side from the light exit surface and has light reflectance lower than that of the first light reflecting portion.

In the above configuration, the light exiting the light source through the light exit surface travels toward the prism sheet. The prism sheet including the first light reflecting portion restricts the light travelling within the prism portion from exiting toward the first light reflecting portion. In the configuration including the light reflecting portion on the prism portions, if the light exiting the lighting device is reflected by the component to be lighted toward the prism sheet, the reflected light is reflected by the light reflecting portion toward the component to be lighted. Such light rays reflected toward the component to be lighted may be directed in an undesired direction (in a direction from the prim portion toward the light reflecting portion) that is to be restricted by the light reflecting portion and it is preferable to reduce such light rays. In the above configuration, the prism sheet includes the first light reflecting portion that controls the light exit direction and the second light reflecting portion that covers the first light reflecting portion from an opposite side from the light source. According to such a configuration, reflected light rays reflected by the component to be lighted toward the prism sheet is not reflected by the first light reflecting portion but by the second light reflecting portion toward the component to be lighted. The second light reflecting portion has light reflectance lower than that of the first light reflecting portion. Therefore, the amount of light rays reflected by the second light reflecting portion toward the component to be lighted is reduced compared to a configuration without including the second light reflecting portion (namely, a configuration in which the light reflects off the first light reflecting portion). As a result, the amount of light rays that are directed in the undesired direction that are to be restricted by the first light reflecting portion is reduced and the exit direction of the light rays exiting the lighting device is controlled more surely.

According to the technology described herein, the exit direction of light exiting the lighting device is surely controlled.

### BRIEF DESCRIPTION OF THE DRAWINGS

FIG. 1 is a cross-sectional view illustrating a general configuration of a liquid crystal display device according to a first embodiment of the present technology.

FIG. 2 is an exploded perspective view illustrating a general configuration of a backlight device included in the liquid crystal display device.

FIG. 3 is a diagram illustrating a brightness angle distribution according to the first embodiment.

FIG. 4 is a graph illustrating a brightness angle distribution according to the first embodiment.

FIG. 5 is a graph illustrating a part of the graph in FIG. 4.

FIG. 6 is a cross-sectional view illustrating a general configuration of a liquid crystal display device according to a second embodiment.

FIG. 7 is a graph illustrating a brightness angle distribution according to the second embodiment.

FIG. 8 is a graph illustrating a part of the graph in FIG. 7.

### DETAILED DESCRIPTION

### First Embodiment

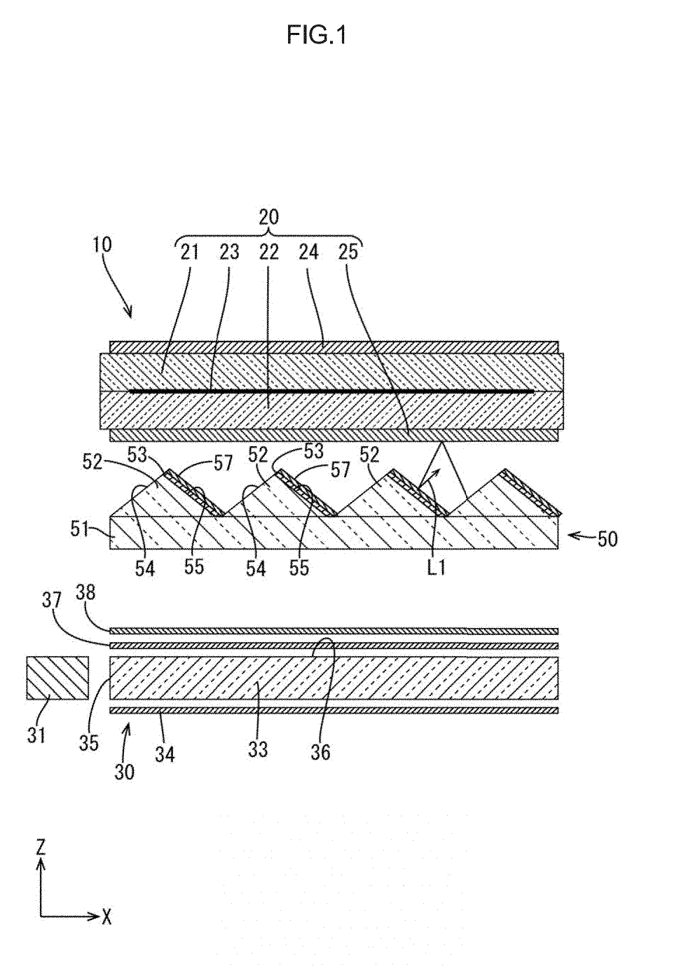

A first embodiment of the present technology will be described with reference to FIGS. 1 to 8. In the present embodiment, a liquid crystal display device 10 will be described as an example. As illustrated in FIG. 1, the liquid crystal display device 10 has a rectangular plan-view shape as a whole, and includes a liquid crystal panel 20 (a display panel) and a backlight device 30 (a lighting device). The backlight device 30 is arranged on a rear side of the liquid crystal panel 20 (on a lower side in FIG. 1) and provides light to the liquid crystal panel 20. The liquid crystal panel 20 has a rectangular plan view shape and displays images thereon with using light from the backlight device 30. The liquid crystal panel 20 includes a pair of substrates 21, 22 and a liquid crystal layer 23 interposed between the substrates 21, 22. The substrates 21, 22 are made of glass that has transmissivity. The liquid crystal layer 23 includes liquid crystal molecules having optical characteristics that change according to application of the electric field.

Among the substrates 21, 22 that are opposite each other, a front-side one is a CF substrate 21 and a back-side one is an array substrate 22. TFTs (thin film transistors), which are switching components, and pixel electrodes are disposed on an inner surface side of the array substrate 22. Gate lines and source lines are routed in a matrix near the TFTs and the pixel electrodes. The gate lines and the source lines receive certain image signals from a control circuit (not illustrated). On the CF substrate 21, color filters are arranged to overlap each of the pixel electrodes. The color filters includes red (R), green (G), and blue (B) color portions that are arranged alternately. A common electrode is arranged on an inner surface of the color filters and opposite the pixel electrodes on the array substrate 22 side. The common electrode may be arranged on the array substrate 22. Alignment films are disposed on the inner surface side of the substrates 21, 22 to align the liquid crystal molecules included in the liquid crystal layer. Polarizing plates 24, 25 are attached to the outer surfaces of the substrates 21, 22. The polarizing plate 25 that is closer to the backlight device 30 is disposed to cover the array substrate 22 (one of the substrates arranged on the lighting device side) from the backlight device 30 side. The polarizing plate 25 is, for example, a circular polarizing plate. The circular polarizing plate includes a linear polarizing plate and a λ/4 retarder.

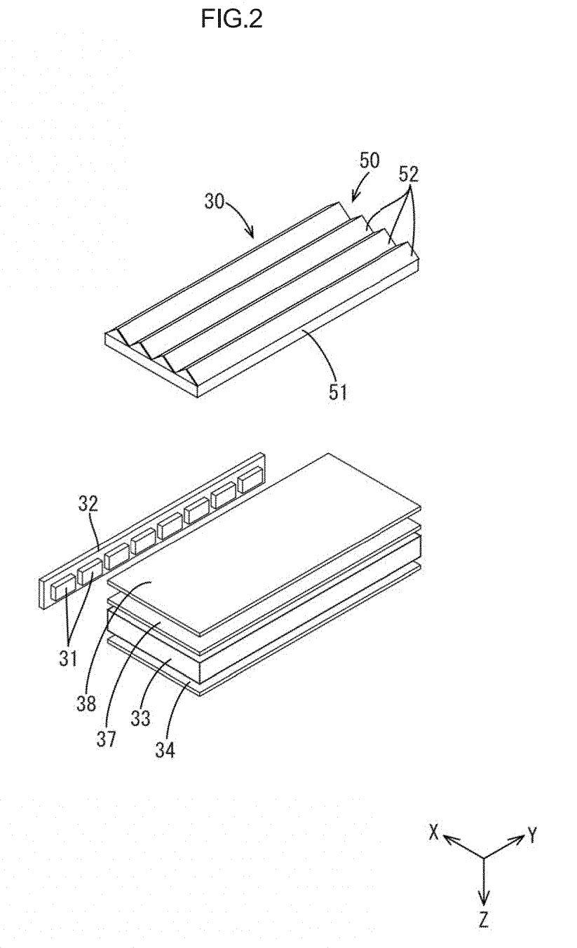

As illustrated in FIG. 2, the backlight device 30 has a plan-view rectangular block shape as a whole. The backlight device 30 includes LEDs 31 (light emitting diodes) that are point light sources, an LED board 32 where the LEDs 31 are mounted, a light guide plate 33 that guides light from the LEDs 31, a light reflection sheet 34 that reflects light from the light guide plate 33, optical sheets 37, 38, and a prism sheet 50 (a light collection sheet). The backlight device 30 includes the LEDs 31 on a long-side edge portion of an outer peripheral portion thereof and light enters through one side surface. The backlight device 30 is an edge-light type (a side-light type). The LED board 32 is a plate member extending in the Y-axis direction (a long-side direction of the light guide plate 33). The LEDs 31 are configured by enclosing LED chips with resin material on a base board that is fixed on the LED board 32. The LEDs 31 are arranged in a line along a longitudinal dimension of the LED board 32 (the Y-axis dimension) at predetermined intervals.

The light guide plate 33 is made of synthetic resin that has refractive index greater than air and high transmissivity and is substantially transparent (acrylic resin such as PMMA). As illustrated in FIG. 2, the light guide plate 33 has a substantially rectangular plan-view plate shape. On the light guide plate 33, a short-side direction matches the X-axis direction, a long-side direction matches the Y-axis direction, and a plate thickness direction that is perpendicular to the plate surface matches the Z-axis direction. Among edge surfaces of the light guide plate 33, one long-side edge surface (a light entrance surface 35) is opposite the LEDs 31. A front-side plate surface of the light guide plate 33 is a light exit surface 36 through which light within the light guide plate 33 exits toward the liquid crystal panel 20 (refer FIG. 1). Light emitted by the LEDs 31 enters the guide plate 33 through the entrance surface 35 and travels within the light guide plate 33 and exits through the light exit surface 36. Namely, the LEDs 31 and the light guide plate 33 configure a planar light source (a light source) having the light exit surface 36. A light reflection sheet 34 is disposed to cover a back-side plate surface of the light guide plate 33. Light that exits the light guide plate 33 through the back-side plate surface is reflected by the light reflection sheet 34 toward the front side.

The optical sheet 37 is disposed to cover the light exit surface 36 from the front side and the optical sheet 38 is disposed to cover the optical sheet 37 from the front side. A light diffuser sheet may be used as the optical sheet 37 and a lens sheet may be used as the optical sheet 38. The optical sheets 37, 38 are not necessarily the above described ones. For example, a reflection type polarizing plate may be used as the optical sheet 38. One example of such a reflection type polarizing plate is “DBEF (registered trademark)” made by SUMITOMO 3M. One optical sheet or three or more optical sheets may be disposed between the light guide plate 33 and the prism sheet 50.

The prism sheet 50 is disposed to cover the optical sheet 38 (eventually the light exit surface 36) from the front side (an opposite side from the light source) and is configured to collect light exiting through the light exit surface 36 with respect to the X-axis direction to improve front brightness. As illustrated in FIG. 1, the prism sheet 50 includes a sheet base member 51 of a sheet member, prism portions 52 (unit light collecting portions), a first light reflecting portion 53, and a second light reflecting portion 57. The prism portions 52 are included on the front side of the sheet base member 51. The first light reflecting portion 53 covers a part of a surface of the prism portion 52 that is on an opposite side from the optical sheet 37. The second light reflecting portion 57 covers the first light reflecting portion 53. The sheet base member 51 and the prism portions 52 are formed by molding transparent synthetic resin such as polycarbonate with extrusion molding and are formed integrally from the same material. The sheet base member 51 and the prism portions 52 may be formed of different materials. The sheet base member 51 may be formed of thermoplastic resin such as polycarbonate and the prism portions 52 may be formed of ultraviolet curing resin.

The prism portions 52 project from the surface of the sheet base member 51 toward the front side (the light exit side). The prism portions 52 extend linearly along the Y-axis direction and arranged in the X-axis direction. Namely, an arrangement direction of the prism portions 52 is parallel to an arrangement direction of the LEDs 31 and the light guide plate 33. Each prism portion 52 is formed in a triangular column having an isosceles triangular cross-sectional shape and has a pair of sloped surfaces 54, 55. The sloped surfaces 54, 55 are surfaces of the prism portion 52 facing the liquid crystal panel 20. The first light reflecting portion 53 is disposed to cover the sloped surface 55 (one of the pair of sloped surfaces). The sloped surface 55 is farther from the LEDs 31 than the sloped surface 54 is. An apex angle of the prism portion 52 (an angle between the pair of sloped surfaces 54, 55) is 90 degrees, for example. A length of the prism portion 52 in the X-axis direction is 50 μm, for example. A thickness of the prism sheet 50 (a thickness of the sheet base member 51 and the prism portion 52) is 155 μm, for example. The values are not necessarily limited to the specific values.

The first light reflecting portion 53 is formed from a thin film formed by disposing aluminum having good light reflectivity on the sloped surface 55 with the oblique vapor deposition. The second light reflecting portion 57 is formed from a thin film formed by disposing chromium over the first light reflecting portion 53. The first light reflecting portion 53 has light reflectance of about 88%. The second light reflecting portion 57 has light reflectance of about 55%. Namely, the light reflectance of the second light reflecting portion 57 is lower than that of the first light reflecting portion 53. The material of the first light reflecting portion 53 and the second light reflecting portion 57 is not limited to the above described ones. The first light reflecting portion 53 preferably has a film thickness of from 30 nm to 1 μm. If the film thickness of the first light reflecting portion 53 is 30 nm or smaller, the light reflectance is lowered, and if the film thickness of the first light reflecting portion 53 is 1 μm or greater, the optical properties of the prism sheet 50 may be adversely affected. The second light reflecting portion 57 preferably has a film thickness of from 20 nm to 1 μm. If the film thickness of the second light reflecting portion 57 is 20 nm or smaller, the light absorption is lowered, and if the film thickness of the second light reflecting portion 57 is 1 μm or greater, the optical properties of the prism sheet 50 may be adversely affected.

Next, advantageous effects of the present embodiment will be described. In the present embodiment, the light exiting the light guide plate 33 through the light exit surface 36 travels toward the prism sheet 50. The prism sheet 50 including the first light reflecting portions 53 reflects the light that travels within the prism portion 52 toward the first light reflecting portion 53 to be directed toward the light guide plate 33 or the slope surface 54. Accordingly, the light rays are less likely to exit the prism position 52 in a directional toward the light reflecting portion 53. In a configuration including the light reflecting portion on the prism portions 52, if the light exiting the backlight device 30 is reflected by the liquid crystal panel 20 (the component to be lighted) toward the backlight device 30, the reflected light is reflected by the light reflecting portion toward the liquid crystal panel 20. Such light rays reflected toward the liquid crystal panel 20 may be directed in an undesired direction (in a direction from the prim portion 52 toward the light reflecting portion, an arrow L1 in FIG. 1) that is to be restricted by the light reflecting portion and it is preferable to reduce such light rays. In the above configuration, the prism sheet 50 includes the first light reflecting portion 53 that controls the light exit direction and the second light reflecting portion 57 that covers the first light reflecting portion 53 from an opposite side from the light guide plate 33. According to such a configuration, reflected light rays reflected by the liquid crystal panel 20 toward the backlight device 30 is not reflected by the first light reflecting portion 53 but by the second light reflecting portion 57 toward the liquid crystal panel 20. The second light reflecting portion 57 has light reflectance lower than that of the first light reflecting portion 53. Therefore, the amount of light rays reflected by the second light reflecting portion 57 toward the liquid crystal panel 20 is reduced compared to a configuration without including the second light reflecting portion 57 (namely, a configuration in which the light reflects off the first light reflecting portion 53). As a result, the amount of light rays that are directed in the undesired direction that are to be restricted by the first light reflecting portion 53 is reduced and the exit direction of the light rays exiting the backlight device 30 is controlled more surely.

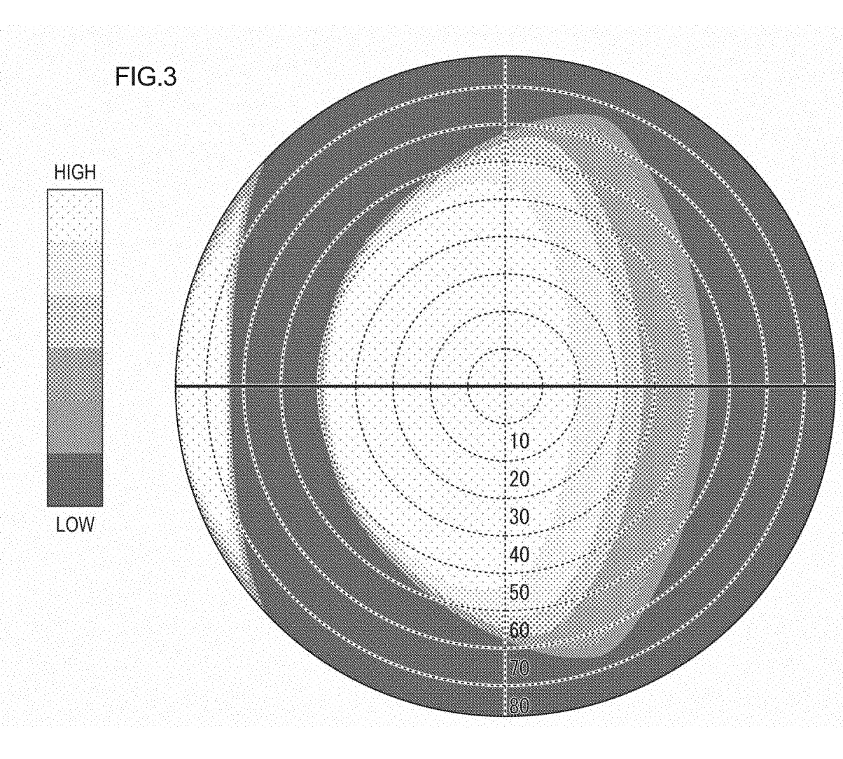

Measurement results of brightness of light rays exiting the backlight device according to the present embodiment are illustrated in FIGS. 3 to 5. FIG. 3 is a diagram illustrating a brightness angle distribution of exiting light rays with respect to a front direction (the Z-axis direction, a direction in which the backlight device is seen from the front side). In FIG. 3, a lateral axis represents outgoing angles with respect to the X-axis direction (angles of an outgoing direction in the X-axis direction with respect to the front direction) and a vertical axis represents outgoing angles with respect to the Y-axis direction (angles of an outgoing direction in the Y-axis direction with respect to the front direction). In FIG. 3, a level of brightness is represented by a density of hatching. The brightness is higher as the hatching density is lower (a bright portion), the brightness is lower as the hatching density is higher (a dark portion).

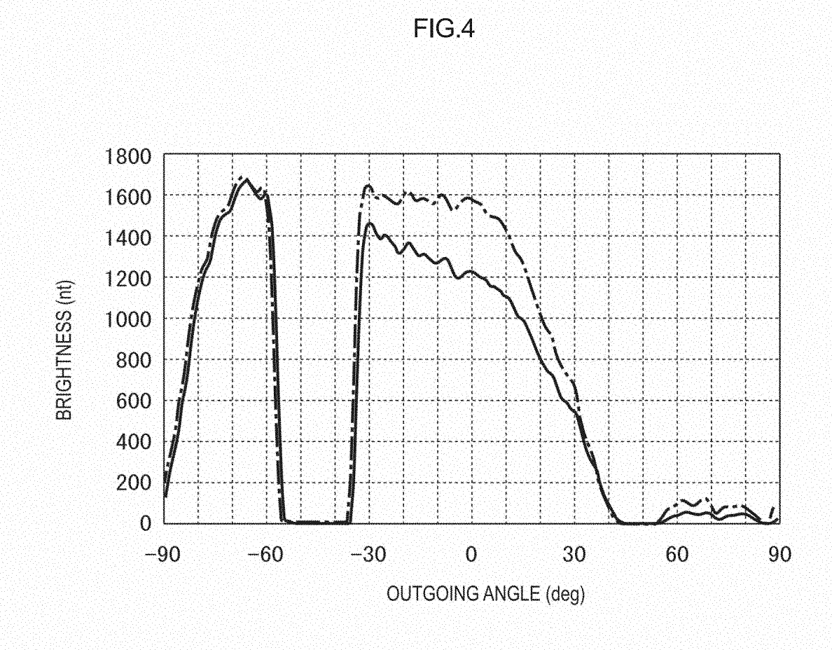

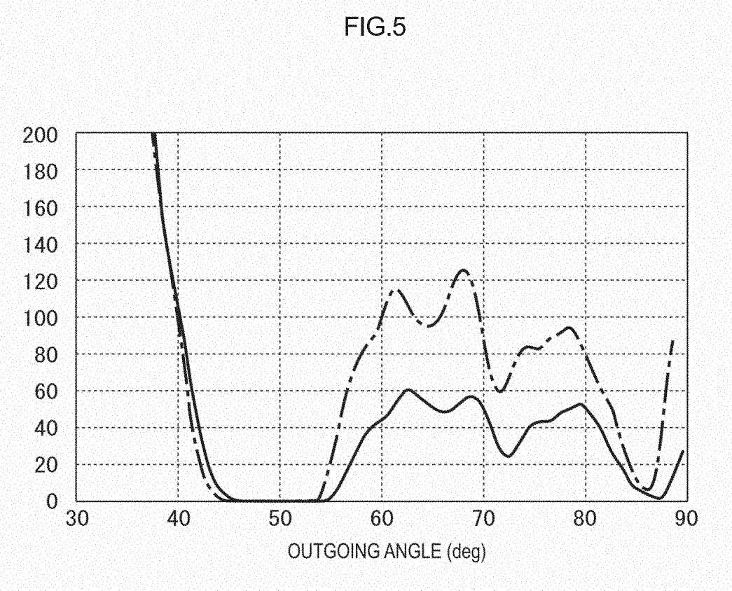

FIG. 4 is a graph illustrating relation between the outgoing angles (the lateral axis) and the brightness (the vertical axis) with respect to the X-axis direction. FIG. 5 is a graph illustrating the range of the outgoing angles from 30° to 90. In each of FIGS. 3 to 5, a left side is closer to the LEDs 31 and a right side is farther from the LEDs 31. In FIGS. 4 and 5, solid lines illustrate brightness of the present embodiment and dashed lines illustrate brightness of Comparative Example without including the second light reflecting portion 57. As illustrated in FIGS. 4 and 5, in the present embodiment, compared to Comparative Example, the brightness of light rays exiting the prism portion 52 in a direction toward the first light reflecting portion 53 is lower (refer the range of the outgoing angles from 55° to 90° in FIG. 5). Accordingly, in the present embodiment including the second light reflecting portion 57, the exit direction of light rays is surely restricted by the second light reflecting portion 57. In Comparative Example (including only the first light reflecting portion 53), the front brightness is about 1600 nt, the brightness in the range of outgoing angles from 60° to 70° is about 120 nt, and the front brightness ratio is 7.5%. In the present embodiment (including the first light reflecting portion 53 and the second light reflecting portion 57 that stacked on each other), the front brightness is about 1200 nt, the brightness in the range of outgoing angles from 60° to 70° is about 60 nt, and the front brightness ratio is 5.0%.

Each prism portion 52 is formed in a triangular column and one sloped surface 55 of the pair of sloped surfaces 54, 55 is covered with the first light reflecting portion 53. According to such a configuration, the light is less likely to exit through the sloped surface 55 and the amount of light rays exiting through the sloped surface 54 is increased.

The liquid crystal panel 20 includes a pair of substrates 21, 22 opposed to each other, the liquid crystal layer 23 disposed between the substrates 21, 22, and the polarizing plate 25 (a circular polarizing plate) covering the substrate 22 on the backlight device 30 side from the backlight device 30 side. The light entering the liquid crystal panel 20 reflects within the liquid crystal panel 20 and is reflected toward the prism sheet 50. The reflected light may be reflected by the second light reflecting portion 57 of the prism portion 52 toward the liquid crystal panel 20 and may exit in the direction that is an undesired light exit direction that is to be restricted by the first light restricting portion. Since the liquid crystal panel 20 includes the polarizing plate 25 (a circular polarizing plate), the light entering the liquid crystal panel 20 is less likely to be reflected toward the backlight device 30. Therefore, the light is less likely to exit in the undesired light exit direction as described before. The polarizing plate 25 that is the circular polarizing plate is configured by stacking the linear polarizing plate and the λ/4 retarder in this order from the backlight device 30 side. According to such a configuration, the light exiting the backlight device 30 passes through the linear polarizing plate and turns to be linearly polarized light when entering the liquid crystal panel 20 and subsequently passes through the λ/4 retarder and turns to be circular polarized light. If such circular polarized light is reflected within the liquid crystal panel 20, the reflected light turns to be circular polarized light having a rotation direction opposite from that of the incident light. The reflected light passes through the λ/4 retarder again and turns to be linearly polarized light that is perpendicular to the incident light and is absorbed by the linear polarizing plate. Therefore, the light that has entered the liquid crystal panel 20 is less likely to be reflected toward the backlight device 30.

In a configuration including a reflection type polarizing plate as the optical sheet 38, the arrangement direction of the prism portions 52 preferably matches (or is preferably perpendicular to) the polarization axis of the linearly polarized light passing through the reflection type polarizing plate. According to such a configuration, the light rays directed from the reflection type polarizing plate toward the prism portion is P-polarized with respect to the light entrance surface of the prism portion 52 (and the first light reflecting portion 53). If the light is refracted or reflected by the prism portion 52 (and reflected by the first light reflecting portion 53), the polarization state of light is less likely to be changed. If the polarization state of light that has transmitted through the reflection type polarizing plate is changed, the amount of light rays transmitting through the polarizing plate 25 of the liquid crystal panel 20 is decreased and light use efficiency is lowered. In the present embodiment, the linearly polarized light that has passed through the reflection type polarizing plate exits the backlight device 30 while keeping the polarization state of the linearly polarized light and therefore, the light use efficiency is further improved. In this section, the change of the polarization state of light means rotation of the polarization axis or phase difference caused by the double refraction.

### Second Embodiment

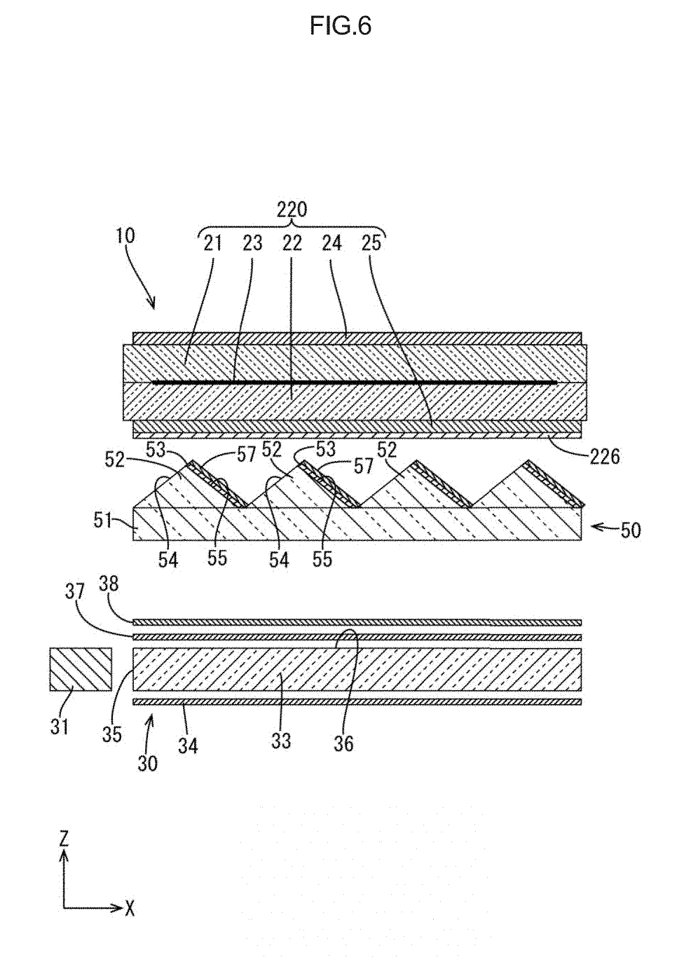

Next, a second embodiment of the present technology will be described with reference to FIGS. 6 to 8. Same components as those of the above embodiment are provided with same symbols and will not be described. A liquid crystal panel 220 of this embodiment includes an anti-reflection layer 226 on a surface thereof opposite the backlight device 30 (a back surface of the polarizing plate 25). An AR coating layer may be used as the anti-reflection layer 226. Specifically, the AR coating layer may be a thin film made of low refractive index material such as magnesium fluoride. The AR coating layer has a film thickness of a ¼ wavelength of visible light such that the reflection light reflecting off the surface of the AR coating layer and the light passing through the AR coating layer and reflecting off an adjacent component are in reversed phases while being displaced with a ½ wavelength. Therefore, the reflection light rays in the reversed phases cancel each other such that the amount of reflection light rays is reduced.

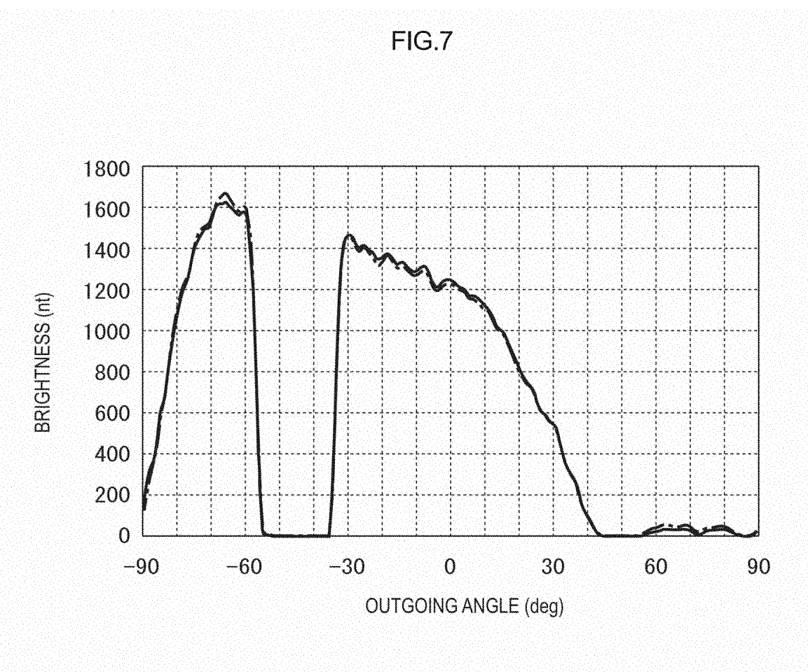

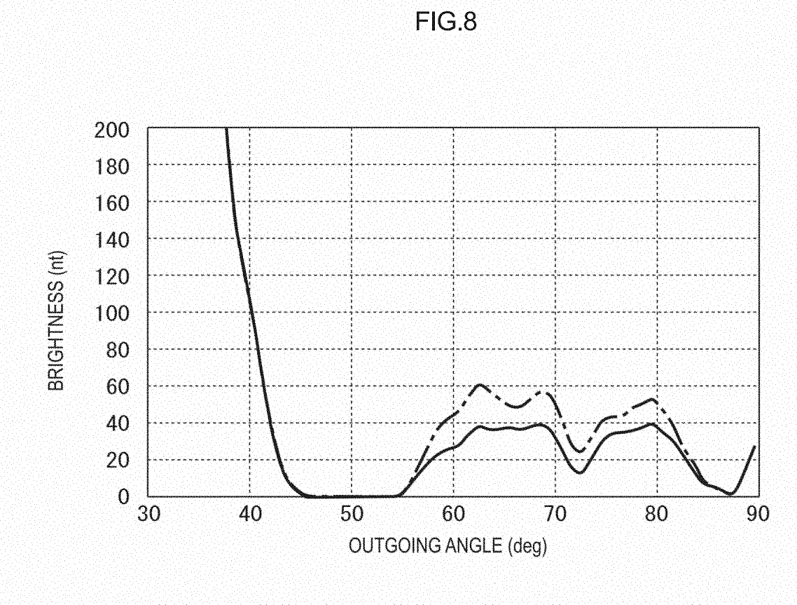

In the present embodiment, if the light reflected by the surface of the liquid crystal panel 220 opposite the backlight device 30 toward the prism sheet 50 is reflected by the second light reflecting portion 57 of the prism portion 52 toward the liquid crystal panel 20, the light may exit the backlight device 30 in the undesired light exit direction in which the light exiting is to be controlled by the first light reflecting portion 53. Such undesired light exiting is less likely to be caused by disposing the anti-reflection layer 226 on the surface of the liquid crystal panel 220 opposite the backlight device 30. FIG. 7 is a graph illustrating relation between the outgoing angles (the lateral axis) and the brightness (the vertical axis) with respect to the X-axis direction in the backlight device 30 of the present embodiment. FIG. 8 is a graph illustrating the range of the outgoing angles from 30° to 90° in the graph of FIG. 7. In FIGS. 7 and 8, solid lines illustrate brightness of the second embodiment and dashed lines illustrate brightness of the first embodiment. As illustrated in FIGS. 7 and 8, in the present embodiment, compared to the first embodiment, the brightness of light rays exiting the prism portion 52 in a direction toward the first light reflecting portion 53 (the right side) is lower (refer the range of the outgoing angles from 55° to 90° in FIG. 8). Accordingly, in the present embodiment including the anti-reflection layer 226, the exit direction of light rays is surely restricted by the first light reflecting portion 53. As illustrated in FIG. 7, in the present embodiment, the front brightness is about 1200 nt, the brightness at the outgoing angles from 60° to 70° is about 40 nt, and the front brightness ratio is 3.3%.

Furthermore, the present embodiment may include an anti-glare layer instead of the anti-reflection layer 226. The anti-glare layer has minute unevenness on a surface thereof to scatter the reflection light. According to such an anti-glare layer, the reflection light reflected by the second light reflecting portion 57 toward the liquid crystal panel 220 is less likely to be directed in a specific direction. Therefore, the light is less likely to exit the backlight device 30 in the undesired light exit direction in which the light exiting is to be restricted by the first light reflecting portion 53. The anti-reflection layer 226 and the anti-glare layer may be stacked on the surface of the liquid crystal panel 220 opposite the backlight device 30. The anti-reflection layer or the anti-glare layer maybe disposed on the back surface of the polarizing plate 25 of the liquid crystal panel 220 (the surface opposite the backlight device 30) or the anti-reflection layer and the anti-glare layer may be disposed on the back surface of the polarizing plate 25 of the liquid crystal panel 220 (the surface opposite the backlight device 30).

### Other Embodiments

The technology described herein is not limited to the embodiments described above with reference to the drawings. The following embodiments may be included in the technical scope.

(1) The present technology may be applied to a direct-type backlight device including only LEDs as the light source.

(2) The first light reflecting portion 53 and the second light reflecting portion 57 may be necessarily disposed on at least a part of the prism portion 52. For example, the first light reflecting portion 53 and the second light reflecting portion 57 may be disposed on the sloped surface 54 (the sloped surface closer to the LEDs 31). The prism portions 52 may be arranged in a direction (the Y-axis direction) perpendicular to the arrangement direction of the LEDs 31 and the light guide plate 33 (the X-axis direction). The LEDs 31 may be arranged opposite two or more side edges of the light guide plate 33.

(3) Another prism sheet including prism portions that are arranged in the Y-axis direction (in a direction perpendicular to the arrangement direction of the prism portions 52) may be disposed between the prism sheet 50 and the light guide plate 33. The prism portions including the first light reflecting portions 53 and the second light reflecting portions 57 may be arranged in the Y-axis direction.

1. A lighting device comprising:
a light source having a light exit surface; and
a prism sheet covering the light exit surface, the prism sheet including prism portions, a first light reflecting portion that covers a part of a surface of the prism portions opposite from the light exit surface, and a second light reflecting portion that covers the first light reflecting portion from an opposite side from the light exit surface and has light reflectance lower than that of the first light reflecting portion.

2. The lighting device according to claim 1, wherein
each of the prism portions has a triangular columnar shape having at least two sloped surfaces, and
the first light reflecting portion covers one of the at least two sloped surfaces.

3. A. display device comprising:
the lighting device according to claims 1; and
a display panel displaying images using light from the lighting device.

4. The display device according to claim 3, further comprising an anti-reflection layer or an anti-glare layer on a surface of the display panel opposite the lighting device.

5. The display device according to claim 3, wherein
the display panel is a liquid crystal panel,
the display panel includes a pair of substrates that are opposite each other, a liquid crystal layer disposed between the pair of substrates, and a circular polarizing plate covering one of the substrates disposed opposite the lighting device from the lighting device side.
